(19) United States
(12) Patent Application Publication
(10) Pub. No.: US 2009/0143516 A1
(43) Pub. Date: Jun. 4, 2009

(54) Thermochromic responsive elastic polymer substrate

(76) Inventors: John Gavin MacDonald, Decatur, GA (US); Stephanie M. Martin, Woodstock, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/998,685

(22) Filed: Nov. 30, 2007

(51) Int. Cl. C08K 5/17

(52) U.S. Cl. 524/236

(57) ABSTRACT

A material composition including a flexible, polymeric matrix and a reverse-thermochromic colorant is described. When subjected to a heat source, the polymeric material can change color from a pale or neutral color to a darker or more vibrant color of a Delta E (ΔE) change of >3. The reverse-thermochromic colorant exhibits a color change when exposed to a heat source within a period of about 30 seconds, and is observable by an unaided human eye under either natural daylight or ambient artificial normal lighting conditions. One or more different reverse-thermochromic colorants in combination may be incorporated. The polymeric matrix surrounds or encapsulates a solvatochromic dye molecule with a phenolate betaine structure. The polymeric matrix includes a dipole orientating agent that induces said solvatochromic dye to express locally when subjected to a temperature change. Various uses for the composition and articles that incorporate the composition are also described, in addition to a method of indicating the temperature of an object or environmental condition.

### FIELD OF INVENTION

The present invention relates to incorporation of a solvatochromic colorant into a flexible polymer substrate matrix or complex. In particular, the invention pertains to an elastic polymer layer or membrane that exhibits a reversible change in color over a temperature range. The polymer membrane can be incorporated into various articles or protective garments for industrial, healthcare, or consumer uses.

### BACKGROUND

Elastic articles have been treated with indicator chemicals to provide a visual indication of a range of triggering events. For example, protective wear such as gloves, for example surgical gloves, may be provided with indicator chemicals that change color in response to contact with certain components of blood or plasma or components of other body fluids, thereby providing a visual warning function to the wearer. Such protective materials are described in U.S. Pat. No. 5,679,399 to Shlenker et al., for example.

In addition, injection molded thermoplastic articles have heretofore been described having visual color indication of the temperature of the article or the temperature of liquids contained within the molded article. For example, such molded thermoplastic articles having thermochromic properties are described in U.S. Pat. No. 6,513,379 to Meyers et al. As described by Meyers et al., thermochromic pigments were incorporated into the thermoplastic melt used to mold infant drinking cups capable of exhibiting color change in response to cold liquids being placed into the cups. Other thermochromic infant feeding containers are described in, for example, U.S. Pat. No. 4,919,983 to Fremin.

In still other cases, thermochromic pigments may be coated onto the fibers of a fabric material, or printed or painted onto film material. However, topical application may lead to color flaws in the surface of the material if the coating is not uniformly applied, along with the undesirable additional cost of such a post-treatment step. Furthermore, such coatings or paintings may have an undesirable lack of resiliency and durability, and may therefore rub off or flake off of the article onto which they are applied. Cracking and flaking of topically applied pigments may be of particular concern where the article onto which the pigment is applied is intended to be repeatedly flexed or bent back and forth, or intended to be used in a fashion that causes repeated stretching and retraction.

U.S. Pat. No. 6,444,313, by Ono et al., cites the use of encapsulated thermochromic pigments in acrylic synthetic fiber. The average encapsulated particle being 0.5 μm to 30 μm in size and comprising an electron-donating color-developing organic compound, an electron-accepting compound and a reaction medium that determine the temperature at which the reaction takes place. U.S. Patent Publication No. 2003/0087566, by Caryle et al., cites the use of these encapaulated thermochromic pigments in meltspun fabrics. Also, U.S. Pat. No. 4,681,791 Yutaka et al., cite the use of encapasulated thermochromic pigments in textile materials. U.S. Patent Publication No. 2006/0246292, Seeboth et al., cites a multilayer composite system comprising a thermochromic layer comprising a thermochromic colorant along with a melting agent. Again the system is transferred from colored to colorless on heating.

All of the above describe the encapsulated thermochromic pigments which are colored at the “cool” temperature and become colorless on warming or heating. In contrast, Yanagita et al. cited the study of a fluoran-based dye which goes from colorless to black on heating with a phenolic catalyst. As such, a need currently exists for an improved elastic articles exhibiting temperature-responsive color change. There still exists a need for a colorant that will undergo reverse-thermochromic properties without the requirement of the complications of either being encapsulated with a catalyst and melting polymer or the need for a phenolic-based catalyst to generate thermochromic properties.

### SUMMARY OF THE INVENTION

The present invention, in part, relates to a material composition having an elastomeric or flexible, polymeric matrix and a reverse-thermochromic colorant including a solvatochromic dye. A “reverse-thermochromic colorant” refers to a colorant that, when heat is introduced to the colorant, exhibits a retro-chromatic change that activates, rather than neutralizes, the coloration of the thermochromic colorant. In other words, whereas conventional thermochromic colorants tend to fade in color when exposed to a heat source, the present thermochromic compounds develop or intensify in color. The unexpected discovery shows that a solvatochromic dye can be incorporated successfully into a nitrile rubber system to display reversable thermochromic properties from an uncolored to colored manifestation. In particular, solvatochromic dyes, such as Reichardt's dye, when added to a nitrile rubber polymer solution changes color at temperatures over a range from about −3-0° C. or 1-5° C. to about 70° C. or 95° C. The solvatorchromic dyes and materials in which they are situated can be sensitive to a change in temperature of at least 2° C. or more in either a localized or general ambient environment around the material.

Another aspect of the invention pertains to an article of manufacture, such as a protective or indicating article, having an elastomeric or flexible polymeric membrane made from either a natural or synthetic latex matrix, and having a dipole-inducing agent, and a solvatochromic dye with a phenolate betaine structure admixed in the latex matrix. The solvatochromic dye has a phenolate betaine structure and exhibits reverse-thermochromic colorant properties. The article of manufacture can be, for example, one of the following: a glove, a face mask, a protective garment, a condom, an inflatable cuff, an external catheter, a catheter balloon, a dilation balloon, an instrument cover, a medical wrap, or a stress indicating article. Alternatively, the article can be a flexible container, such as a pouch or bag, or a sticker or temporary tattoo for novelty, healthcare or medical uses.

According to yet another aspect, the invention relates to a method for indicating a change in localized body temperature or other environmental conditions. The method comprises providing an article having an elastic or flexible polymeric matrix, with a dipole-inducing agent and a solvatochromic dye with a phenolate betaine structure admixed in the polymeric matrix; applying a change in temperature to the localized environment around the article or to the matrix itself to cause a manifestation of a color change from a translucent or uncolored state to an opaque or colored state.

In other embodiments, the present invention provides a thermochromic elastic article that includes a first elastic polymeric composition having elastomeric polymer selected from the group consisting of elastomeric emulsion polymers and elastomeric solution polymers, (e.g., natural rubber latex polymers or synthetic latex polymers). The first elastic polymeric composition further includes a first reverse-thermochromic colorant having a solvatochromic dye with a phenolate betaine structure that is substantially uniformly dispersed in the elastic polymeric composition, wherein said reverse-thermochromic colorant exhibits a change in color wavelength of at least about 10 nm over the human visible spectrum, of about 400 nm to about 700 nm.

The reverse thermochromic colorant is present in the elastic polymeric composition from between about 0.1 weight percent and about 10 weight percent, or desirably between about 0.5 weight percent and about 7 weight percent of reverse thermochromic colorant. The first elastic polymeric composition may further include a second reverse thermochromic colorant. According to one embodiment, the reverse thermochromic colorant may have a first transition temperature and the second reverse thermochromic colorant has a second transition temperature, such that the difference between the first transition temperature and the second transition temperature is not more than about 1° C. In another embodiment, the difference between the first transition temperature and the second transition temperature is at least about 2° C., or about 4° C. Alternatively, the thermochromic elastic article may further include at least one non-thermochromic pigment. The article may have a multilayer construction, such that the second elastic polymeric composition is substantially the same as the first elastic polymeric composition. In a multilayered construction, the reverse thermochromic colorant in the second elastic polymeric composition differs from the reverse thermochromic colorant in the first elastic polymeric composition. The reverse thermochromic colorant in the first elastic polymeric composition has a first transition temperature, and the reverse thermochromic colorant in the second elastic polymeric composition has a second transition temperature, wherein the difference between the first transition temperature and the second transition temperature is at least about 2° C. One may use the thermochromic elastic article to make an article of manufacture, which may include a glove, a medical wrap, a garment and a stress indicating article.

Additional features and advantages of the present invention shall be explained in the following detailed description. It is understood that the foregoing general description and the following detailed description, figures, and examples are merely representative of the invention, and are intended to provide an overview for understanding the invention as claimed.

### BRIEF DESCRIPTION OF FIGURES

The accompanying figures illustrate a material sample that exhibits a visual change from a translucent or uncolored state to a colored state.

FIG. 1 depicts a representation of a polymeric latex glove 10, according to an embodiment of the present invention, in which the glove is subjected to a source of heat 2 at the tip 12 of a finger 14, which causes the reverse-thermochromic colorant in the glove material 16 to begin to manifest a thermochromic change from a light colored or colorless appearance to one that is darker or deeper, or colored 18. The color change occurs nearly instantaneously and remains observable for duration of at least 5 seconds.

FIG. 2 shows the same glove as in FIG. 1, with a larger area of the glove material manifesting the color change along the forefinger 14.

FIG. 3 shows a latex glove with all of the finger areas 20 showing a color change, which in some embodiments will proceed to the palm 22 and the rest of the hand 24.

### DETAILED DESCRIPTION OF THE INVENTION

### SECTION I.—DEFINITION

The term “thermochromic,” as used herein, refers to colorant ingredients such as pigments, dyes, and the like, which undergo a change in color upon a change in temperature. Additionally, the term “thermochromic” refers to materials or articles that include such ingredients, whereby the materials or articles are capable of exhibiting a color change in response to a change in temperature.

The term “reverse-thermochromic colorant” refers to a colorant that exhibits a retro-chromatic change when heat is applied to the colorant. The retro-chromatic change activates, rather than neutralizes the coloration of the colorant.

The terms “elastic” or “elastomeric” are used generally to refer to a material or article that, upon application of a stretching or biasing force, is capable of being extended, stretched, or elongated, in at least one direction, without rupturing, to an extended or elongated dimension, and which upon release of the stretching force, will recover substantially to within at about 50% of extended dimension. By way of illustration, an elastic material having an original, relaxed, length of about 10 cm may be elongated to about 13 cm by application of a force. Upon release of the force, the elastic material recovers to a length of not more than about 12 cm.

### SECTION II.—DESCRIPTION

The present invention describes unexpected reverse thermochromic properties of polarity-sensitive dyes or solvatochromic dyes in flexible polymeric matrices. With an increase in relative temperature, the color manifestation is enhanced or deepened in color, rather than deactivates or fades in color. Solvatochromic dyes are dyes whose absorption or emission spectra are sensitive to and altered by the polarity of their surrounding environment. Typically, these dyes exhibit a shift in peak emission wavelength due to a change in local polarity. Polarity changes which cause such wavelength shifts can be introduced with a modification of the substrate matrix used for a particular chemical or physical change in the surrounding micro-environment.

The colorant exhibits a perceivable change in color wavelength of at least about 10 nm over the human visible spectrum, of about 400 nm to about 700 nm. Typically, the colorant expresses a color change of about 20-30 nm, or about 30 or 40 nm to about 100 or 130 nm. More typically, one can observe a wavelength shift of about 20 nm up to about 200 nm, desirably about 50-60 nm. Additionally, according to certain embodiments, the colorant can manifest a change in the hue or shade of a particular color for greater richness and depth. For instance, the colorant according to the invention can transform from a pale blue or red shade to a blue-purple or dark burgundy color.

Current commercial or conventional thermochromic materials operate by neutralizing a colorant in the material, which causes the manifest appearance of the material to fade or turn a lighter color than before the material is exposed to a heating source. Unlike with conventional thermochromic materials, in the present invention when a sufficient amount of heat is applied to the polymeric material containing solvatochromic colorant, the visual appearance of the material changes from a first color to at least a second color that is observably deeper, richer, or more intense than the first color. In other words, heat induces the colorant to have a cumulative or additive visual effect. One observes with increasing temperature either a shift toward in color or a deepening of the hue.

As mentioned above, it is believed that a change in polarity creates a characteristic optical response signature. The present invention, according to one aspect, provides a material composition that incorporates solvatochromic dye with a phenolate betaine structure which can exhibit a reverse-thermochromic color change. Generally, the colorant can change color at temperatures over a relatively wide range from about −5° C. or 0° C. up to about 90-95° C., inclusive. More typically, the temperature range of operation can be from about 1-3° C. up to about 50-85° C., or from about 5-10°C. up to about 40-65° C., inclusive. In particular embodiments, the temperature range can be from about 15-20° C. up through room temperature (˜25-28° C.) to about 30-45° C., inclusive The colorant exhibits a change in color from an uncolored state to a colored state over a minimal temperature difference of about 1.5-2° Celsius. The colorant exhibits a perceivable color change in wavelength of at least about 10 nm over human visible spectrum.

The elastomeric or flexible matrix is made of either a natural or synthetic latex resin. In certain embodiments, the latex resin is an acrylo-nitrile butadiene resin. The present invention also pertains to articles of manufacture that incorporate or use a polymeric matrix having a solvatochromic colorant. The flexible matrix may be made of either a natural or synthetic latex resin, such as natural rubber latex, isoprene, or nitrile butadiene. Elastomeric rubber materials can be made into gloves, face masks, protective garments, balloons, condoms, or other medical and consumer products. Alternatively, the article may be a flexible container, such as a pouch or bag, or a sticker or temporary tattoo design.

The solvatochromic dye has a phenolate betaine structure. According to a desirable embodiment or example, the phenolate betaine dye is Reichardt's dye, which we have discovered can impart novel thermochromic properties to a nitrile latex material. Particular embodiments that can be incorporate include, for instance, Reichardt's dye which is a colorless species in the polymer matrix until the application of heat, at which point the polymer matrix begins to change color. It is desirably that the color change is actuated without the use of a melting agent or developers. Not to be bound by theory, however, it is believed that a shift or twisting of the molecular structure either energizes or de-energizes the electron cloud distribution, causing a change in the relative dipole orientation of the dye molecule. According to the invention, one can incorporate in the polymeric matrix one or more different colorant species in combination to enable the material to manifest different colors over a temperature range or at various predetermined temperatures. Hence, a user may be able to sense or tell, not only by touch, but also by visual input the relative temperature of an object or environment with which the polymer material comes in contact.

Although the thermochromism of Reichardt's dye, for example, has been discussed in several publications, including U.S. Patent Publication No. 2006/0246292 A1, incorporated herein by reference, which describes the creation of extruded polymer layers with thermochromic properties incorporating Reichardt's dye, the published sources describe typical thermochromic properties in polyolefin resins where a blue color at room temperature is neutralized or discharged by the application of heat. At present, however, no literature has been found which describes the incorporation of Reichardt's dye into a latex matrix, for example a nitrile rubber protective article, or which utilizes a similar processing methodology to create a reverse thermochromic product such as a such as a glove, cap, sleeve, or condom, or other barrier having Reichardt's dye.

According to an embodiment of the present invention, when making a polymer latex article such as a rubber glove, one can use a ceramic or metallic mold or former that is dipped into a conventional calcium nitrate (CaNO₃) coagulant and then dipped into a nitrile solution containing an amount of Reichardt's dye. The dye is added to the solution at a concentration of approximately 0.01% to about 10% by weight. Typically, one may use a concentration of about 0.1% to about 5% or 7%, or about 0.17% to about 3%, more desirably about 0.2% to about 0.5%, inclusive. The pH of the dye solution is adjusted using a strong base, such as NaOH or KOH, to a final pH of between about 8-12, or more usually about 9-11. In an example, the concentration of dye is about 0.2% and the pH is approximately 10.0, and a small amount (approximately 5 mL) of surfanol is added to the solution to enhance solubility of the Reichardt's dye. Addition of the strong base caused a color change from white to pink. After dipping the former into this mixture, a standard acrylonitrile glove making procedure is followed. When drying in an oven at about 70° C., the rubber material undergoes a color change. Under heat, the glove turned a very dark pink, but upon cooling to room temperature (˜20-25° C.) the light color is restored. An additional glove sample was made by adding 0.2% Reichardt's dye directly to the coagulant solution. The mold is again dipped in the coagulant, and then dipped into the nitrile/Reichardt's dye/KOH/surfanol mixture, followed by standard glove making practice. One again notices that drying in the oven results in a color change to a deep magenta, but that the original crème or very pale pink color is restored when cooled to room temperature. The deep color could also be generated by gently applying heat from a heating source (e.g., heat gun) to the nitrile for less than a minute (˜5, 10, 20, 30, 40, 50 seconds). The greater the heat intensity, the darker the glove material become. In other examples, when a source of heat, such as a heat gun, is applied to raise the temperature of a nitrile rubber membrane containing Reichardt's dye, the nitrile rubber membrane exhibits a heat-induced color change, from a translucent or pale white to a deep, dark bluish purple color.

In another instance, one can incorporate Reichardt's dye in latex polymers to produce a colorless material at room temperature that turns to a vivid purple pink in color when heat is applied to the material. This phenomenon exhibits novel reverse thermochromic properties that have not been previously described. In another embodiment, a solvatochromic dye, Nile Red (Eastman Kodak, Rochester, N.Y.) exhibits large shifts in its emission wavelength peak with changes in the local environment polarity. This phenomenon can be useful for both encoding subpopulations of bead types and for detecting specific target analytes in certain bioassay applications.

It is worth noting that previous attempts to incorporate Reichardt's dye into polymer melts (using an extruder for instance) or onto other substrates or polymers have not resulted in observation of a reversible thermochromic shift. For example, Reichardt's dye (1%) was added to polyethylene resin and extruded to make a film that was blue in color, but the film does not undergo a color change when exposed to heat. Similarly, other previous studies which coated Reichardt's dye onto various substrates, such as nonwoven spongbond-meltblow-spongbond (SMS) laminates, cellulose based papers, or woven cloth fabrics (e.g., wool, cotton, flax linen) did not result in any observable thermochromism. Hence, the observable results of the present addition are rather surprising.

The solvatochromic nature of Reichardt's dye leads to different colors may depend on the solvent environment. According to the present invention, Reichardt's dye undergoes a color change when in contact with adhesives. The duration of this color change can be controlled by the thickness of the dye's coating to produce time intervals from minutes to hours. Dissolution of Reichardt's dye into certain solvents (such as glycerol, methanol, etc) results in a red color, while dissolution into other solvents (such as acetonitrile, isopropanol, etc) result in a bluish/purplish color. When solutions of Reichardt's dye in methanol and in glycerol were heated using a heat gun, the solutions underwent a shift from pink to deep red/violet. Application of heat to a purple solution of Reichardt's dye in acetonitrile did not cause any observable color change. Literature reports, however, suggest that thermochromism should be possible in this solvent. The shift may be too small, however, to be immediately visible to the naked eye. It appears that the best conditions for usage of Reichardt's dye as a thermochromic visual indicator would be to leverage solvents and polarity environments that favor the shift of deep magenta. Nitrile (or additives in the glove solution) appears to create this environment.

The polymeric matrix includes a dipole orientating agent that can induce the solvatochromic dye to express locally when subjected to a temperature change. Generally, a dipole-inducing agent can be one or a combination of the following: glycerin, tetrahydrofuran, pyridine, dimethylformamide, isopropanol, or acetonitrile. In certain desirable embodiments, the dipole-inducing agent has an acid group, such as a methacrylic acid.

The colorant composition of the present invention differs significantly from commercially available thermochromic colorants. First, the present invention incorporates either a single dye or a mixture of dyes that manifest actively or “positively” a color change from the absence of color (white or grayish) pigmentation to color. In other words, the composition of the present invention develops color upon warming or heating. This phenomenon is an exactly opposite manifestation of the state of the art with commercial thermochromic colorants, which progress from colored to colorless when exposed to heat. Second, when incorporated into the polymeric matrix the dye is not encapsulated with a color developer catalyst. The catalyst is not needed to manifest color change according to the present invention. In contrast, current commercial thermochromic pigments comprise an encapsulated particle that includes at least two chemical components—a leuco dye and a color developer. The leuco dyes, which are weak organic bases, change from colored to colorless (clear) upon heating and normally function over a 5° C. to 15° C. temperature range. The changing temperature shifts the equilibrium between the colored or protonated form of the dye, where the proton is generally donated by the color developer (e.g. a weak acid) and the unprotonated or colorless form.

### Part A.—Colorants

Generally speaking, regardless of the form of particular form or species of the reverse thermochromic ingredient used, the reverse thermochromic colorant will be present in the elastic polymeric composition in an amount sufficient to provide a base level of contrast after undergoing transition with the previous color of the thermochromic elastic article. Again, generally speaking, such sufficient amounts of thermochromic pigment in the elastic polymeric composition may range from less than about 0.1 weight percent (by weight of the entire elastic polymeric composition) to about 10 weight percent, or greater. In addition, the thermochromic elastic articles may optionally include one or more non-thermochromic pigments or colored elements; i.e., those that do not change color as temperature changes.

Depending on desired end-use application, desired color intensity (and color contrast intensity), presence of other pigments (including non-thermochromic pigments) and the like, the thermochromic pigment in the elastic polymeric composition may range from about 0.15 weight percent to about 7 weight percent of the elastic polymeric composition. More particularly, the reverse thermochromic colorant in the elastic polymeric composition may range from about 0.2 or 0.5 weight percent to about 5 weight percent of the elastic polymeric composition.

Conventionally, thermochromic systems (e.g., leuco dye, color developer, and polar solvent) encapsulated the agent together within a particle. The particle shell serves to isolate the color changing components from the surrounding environment, thereby producing a system that is stable and reversible upon exposure to temperature changes. The components would not function if they were just mixed into the matrix. In most products the thermochromic agent are passive and do not provide any feedback to the user. The business opportunity to develop products that would inform or alert the user during use are seen as disruptive in nature and could provide an advantage that can change the basis of competition in the market place. To this end, the inventors identified a set of dyes that gave reverse thermochromic properties. These dyes are not well known and only reported as academic curiosity items for measuring the polarity of solvent systems. The inventors have identified and developed a number of dye-based systems where the appearance of color is designed to inform or alert the user to a situation that requires action by the user.

Traditionally, thermochromic dyes have been based on mixtures of leuco dyes that have suitable other chemicals, displaying a color change (usually between a colorless leuco form a a colored form) in dependence on temperature. The dyes are rarely applied on materials directly; they are usually in the form of microcapules with the mixture sealed inside. An illustrative example is the Hypercolor fashion, where microcapsules with crystal violet lactone, a weak acid, and a dissociable salt dissolved in dodecanol are applied to the fabric. When the solvent is solid, the dye exists in its lactone leuco form, while when the solvent melts, the salt dissociates, the pH inside the microcapsule lowers, the dye becomes protonated, its lactone ring opens, and its absorption spectrum shifts drastically, therefore it becomes deeply violet. In this case the apparent thermochromism is in fact halochromism. Examples of leuco dyes include spirolactones such as fluorans or crystal violet lactone, spiropyrans, fulgides, and the like. The color developers are weak acids (i.e., proton donors or electron acceptors). Examples of such components include bisphenol A, octyl p-hydroxybenzoate, methyl p-hydroxybenzoate, parabens, 1,2,3-triazole or its derivatives, 4-hydroxycoumarin derivatives, and the like, which act as proton donors, changing the dye molecule between its leuco form and its protonated colored form. Stronger acids can make the change irreversible. A third component for an organic-dye system (such as a leuco dye) is generally a polar solvent such as an alcohol, ester, ketone, or ether. Examples include lauryl alcohol (i.e., 1-dodecanol), cetyl alcohol (i.e., 1-hexadecanol), and butyl stearate.

A disadvantage of conventional leuco dye systems is that they exhibit less accurate temperature response than liquid crystals, and are used in applications where temperature response accuracy is not critical. They are suitable for general indicators of approximate temperature (“too cool”, “too hot”, “about OK”), or for various novelty items, such as in novelties, toys, or approximate temperature indicators for microwave-heated foods. They are usually used in combination with some other pigment, producing a color change between the color of the base pigment and the color of the pigment combined with the color of the non-leuco form of the leuco dye. Organic leuco dyes are available for temperature ranges between about −5° C. to about 60° C., in wide range of colors. The color change usually happens in a 3° C. interval. Microencapsulation allows their use in wide range of materials and products. The size of the microcapsules typically ranges between 3-5 μm (over 10 times larger than regular pigment particles), which requires some adjustments to printing and manufacturing processes. Another disadvantage is that exposure to ultraviolet radiation, solvents and high temperatures can reduce the lifespan of leuco dyes. Temperatures above about 200-230° C. typically cause irreversible damage to leuco dyes; a time-limited exposure of some types to about 250° C. is allowed during manufacturing.

In the present invention, solvatochromic dyes have spectroscopic characteristics (e.g., absorption) in the ultraviolet/visible/near-infrared spectrum and are sometimes influenced by the surrounding medium. The solvatochromic dyes may be positive or negative, which corresponds to bathochromic and hypsochromic shifts, respectively, of the emission band with increasing solvent polarity. For instance, the solvatochromic dye may undergo a color change in a certain molecular environment based on solvent polarity and/or hydrogen bonding propensity. This is demonstrated by the fact that a solvatochromic dye may be blue in a polar environment (e.g., water), but yellow or red in a non-polar environment (e.g., lipid-rich solution). The color produced by the solvatochromic dye depends on the molecular polarity difference between the ground and excited state of the dye.

Merocyanine dyes (e.g., mono-, di-, and tri-merocyanines) are another example of a type of solvatochromic dye that may be considered in this technical report. Merocyanine dyes, such as merocyanine 540, fall within the donor—simple acceptor chromogen classification of Griffiths as discussed in “Colour and Constitution of Organic Molecules” Academic Press, London (1976). More specifically, merocyanine dyes have a basic nucleus and acidic nucleus separated by a conjugated chain having an even number of methine carbons. Such dyes possess a carbonyl group that acts as an electron acceptor moiety. The electron acceptor is conjugated to an electron donating group, such as a hydroxyl or amino group. The merocyanine dyes may be cyclic or acyclic (e.g., vinylalogous amides of cyclic merocyanine dyes). For example, cyclic merocyanine dyes generally have the following structure:

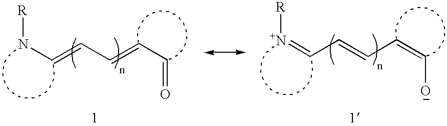

wherein, n is any integer, including 0. As indicated above by the general structures 1 and 1′, merocyanine dyes typically have a charge separated (i.e., “zwitterionic”) resonance form. Zwitterionic dyes are those that contain both positive and negative charges and are net neutral, but highly charged. Without intending to be limited by theory, it is believed that the zwitterionic form contributes significantly to the ground state of the dye. The color produced by such dyes thus depends on the molecular polarity difference between the ground and excited state of the dye. One particular example of a merocyanine dye that has a ground state more polar than the excited state is set forth below as structure 2.

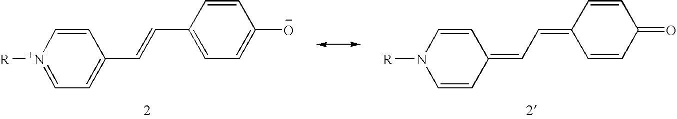

The charge-separated left hand canonical 2 is a major contributor to the ground state whereas the right hand canonical 2′ is a major contributor to the first excited state. Still other examples of suitable merocyanine dyes are set forth below in the following structures 3-13.

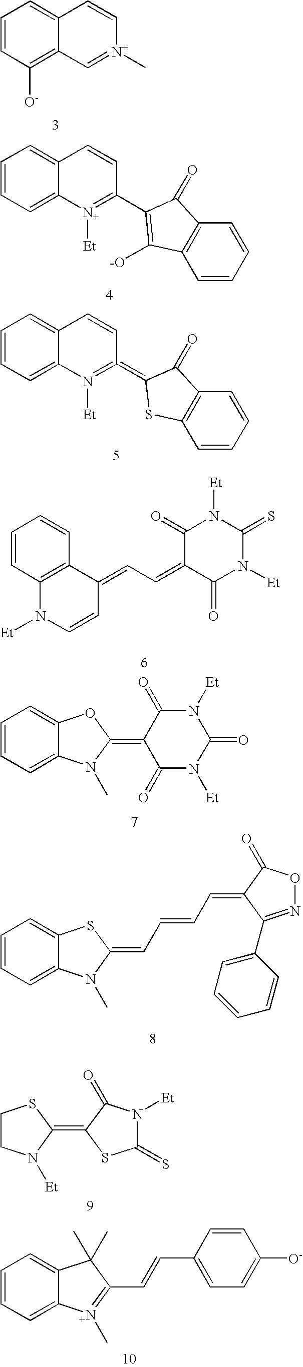

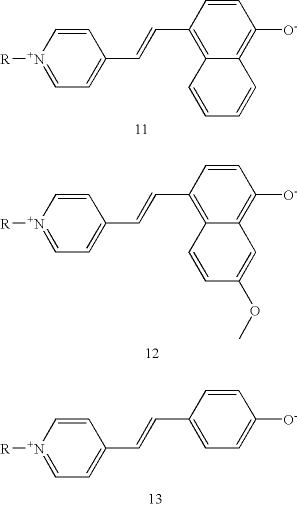

wherein, “R” is a group, such as methyl, alkyl, aryl, phenyl, etc.

Indigo is another example of a suitable solvatochromic dye. Indigo has a ground state that is significantly less polar than the excited state. For example, indigo generally has the following structure 14:

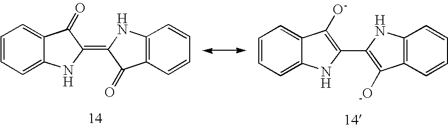

The left hand canonical form 14 is a major contributor to the ground state of the dye, whereas the right hand canonical 14′ is a major contributor to the excited state.

It is believed that the particular ability for the colorant molecule to exhibit resonance in certain solvent systems, or depending on the shape or orientation of the molecule to pivot and torque along an axis of rotation may contribute to the color manifestation.

Other solvatochromic dyes include those that possess a permanent zwitterionic form. That is, these dyes have formal positive and negative charges contained within a contiguous π-electron system. Contrary to the merocyanine dyes referenced above, a neutral resonance structure cannot be drawn for such permanent zwitterionic chromogens. Exemplary dyes of this class include betaine dyes, such as 4-(2,4,6-triphenylpyridinium-1-yl)-2,6-diphenylphenolate (Reichardt's dye) having the following general structure 15.

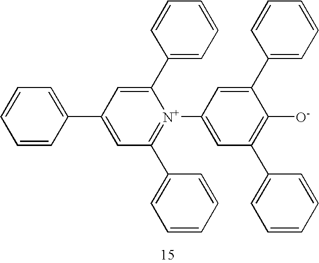

Pyridinium N-phenolate betaine dyes are a subset of the solvatochromic dye class as they change color when the polarity of the solvent is changed. This chameleon-like property is quite striking. Reichardt's dye shows strong negative solvatochromism. That is, Reichardt's dye displays a shift in absorbance to a shorter wavelength and thus has visible color changes as solvent eluent strength (polarity) increases. Table 1 summarizes the different colors that Reichardt's dye manifests in various solvents.

TABLE 1

| | |
|---|---|
| Solvent Environs | Manifest Color |
| Glycerin | Orange/pink |
| Tetrahydrofuran | Dark green |
| Pyridine | Turquoise |
| Dimethylformamide | Light green |
| Isopropanol | Light blue |
| Acetonitrile | Light purple |

Table 2 shows the colors of other additional solvatochromatic dyes dissolved in different solvents.

TABLE 2

| | Solvent 1 | Solvent 2 | Solvent 3 |
|---|---|---|---|
| Solvatochromic Dye | Acetonitrile | Acetone | isopropanol |
| Betaine RD | Magenta | Yellow | light blue |
| (R1-R5 = phenyl) | | | |
| Betaine 1 dichloro | Purple | Violet | magenta |
| (R1, R5 = Cl, R2-R4 = phenyl) | | | |
| Betaine 2 | Blue | Green | violet |
| (R1, R5 = H, R2-R4 = phenyl) | | | |

Still other examples of negatively solvatochromic pyridinium N-phenolate betaine dyes are set forth below in structures 16-22:

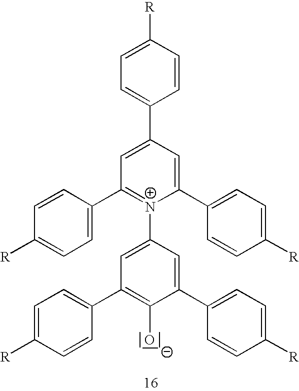

wherein, R is hydrogen, —C(CH₃)₃, —CF₃, or C₆F₁₃.

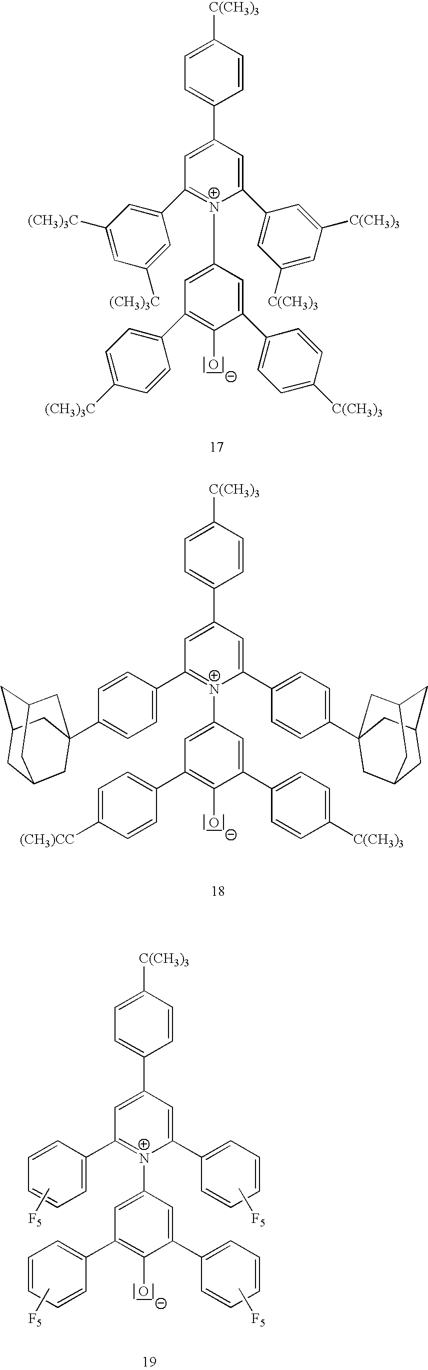

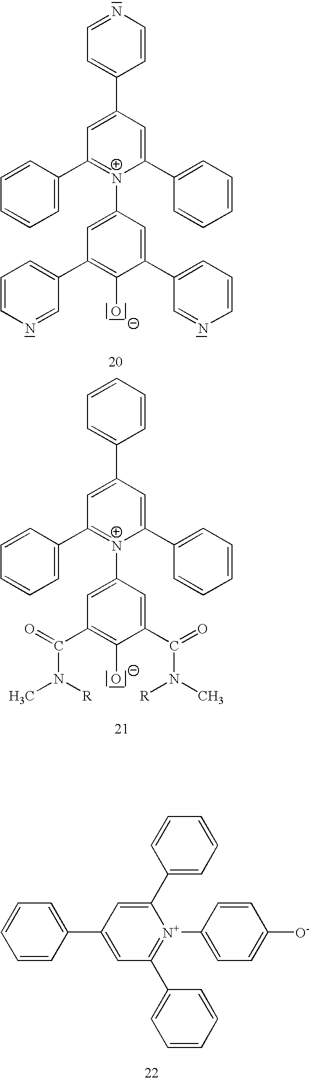

Still additional examples of dyes having a permanent zwitterionic form include dyes having the following general structure 23:

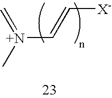

wherein, n is 0 or greater, and X is oxygen, carbon, nitrogen, sulfur, etc. Particular examples of the permanent zwitterionic dye shown in structure 23 include the following structures 24-32.

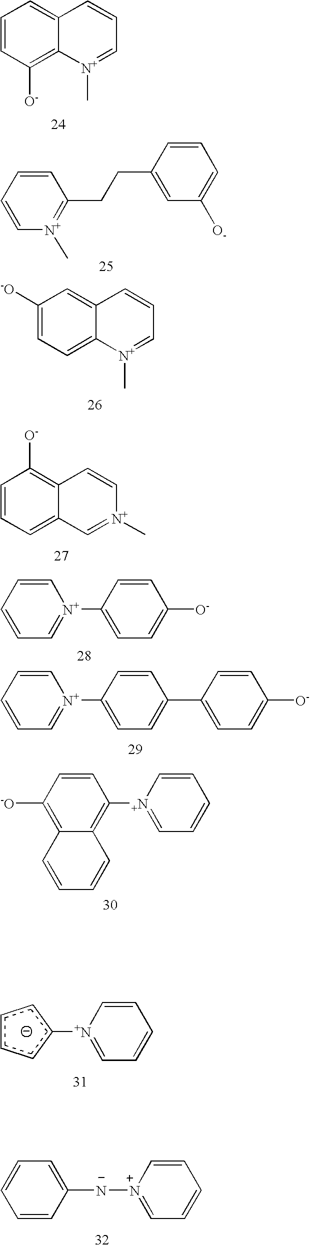

Still other suitable solvatochromic dyes may include 4-dicyanmethylene-2-methyl-6-(p-dimethylaminostyryl)-4H-pyran (DCM); 6-propionyl-2-(dimethylamino)naphthalene (PRODAN); 9-(diethylamino)-5H-benzo[a]phenox-azin-5-one (Nile Red); 4-(dicyanovinyl)julolidine (DCVJ); phenol blue; stilbazolium dyes; coumarin dyes; ketocyanine dyes; N,N-dimethyl-4-nitroaniline (NDMNA) and N-methyl-2-nitroaniline (NM2NA); Nile blue; 1-anilinonaphthalene-8-sulfonic acid (1,8-ANS), and dapoxylbutylsulfonamide (DBS) and other dapoxyl analogs.

### Part B—Polymeric Matrix

The present invention provides articles of manufacture that are made with an elastic, polymeric material that incorporates a reverse thermochromic colorant. The thermochromic elastic article includes an elastic polymeric composition having at least one elastomeric polymer. The polymeric material matrix typically is formed from either natural or synthetic rubber latexes. As persons in the art understand, the term “latex” generally refers to a group of similar material preparations having stable dispersion of polymer molecules or microparticles in a liquid matrix (usually water). The elastomeric polymer or polymers are selected from any suitable elastomeric emulsion-based polymers and elastomeric solution-based polymers. As used herein, emulsion-based polymers include polymers dispersed in liquids such as aqueous or other liquids.

In certain embodiments, the elastic polymeric composition includes at least one thermochromic colorant that is substantially uniformly dispersed therein. By “substantially uniformly dispersed” in the elastic polymeric composition, it is meant that the thermochromic colorant is relatively well mixed, as by stirring or other means, into the liquid of the emulsion or solution (along with the elastomeric polymer and any other ingredients) prior to the thermochromic, elastic article being formed from the elastic polymeric composition. As used herein, thermochromic “colorant” is intended to be inclusive and includes thermochromic pigments provided in powdered or liquid suspension form, thermochromic dyes and thermochromic inks and the like.

In certain embodiments, more than one reverse thermochromic colorant or dye may be combined to provide for obtaining multiple color changes as the temperature changes. For example, a reverse thermochromic colorant that undergoes a color change from about 0° C. or 1° C. up to about room temperature (˜20-23° C.) may be combined with a second reverse thermochromic colorant or conventional thermochromic pigment having a color change transition temperature or temperature range from about 25° C. or 26° C. up to about 38° C. or 40° C. As the article with the combination is warmed from about 18° C. or 20° C. to about 32° C. or 35° C., for example, it would proceed through two color changes. Depending one the particular desired visual effect and temperature ranges that the colorants transition, one can adapt the reverse thermochromatic ingredients to accommodate various ranges, for instance, with one colorant having a transition in the range from about 4° C. to about 12° C., and another colorant from about 40° C. or 50° C. up to about 85° C. The particular use and visual manifestation will dictate the active temperature ranges and desired colors that an article or product would incorporate.

According to a variation, the mixture of two or more reverse thermochromic colorants or dyes may have different colors and different transition temperatures. For example, one thermochromic pigment may be selected that is red, initially, and then transitions to a deep purple, for instance, at about 29° C. A second reverse thermochromic pigment or dye may be selected that is green, initially, and then transitions to brown at, for example, about 33° C. (or the green pigment itself may consist of other colors, e.g. yellow and blue, that transition approximately together). The combination or mixture of these two thermochromic pigments is initially brownish in appearance.

A variety of different kinds of polymeric latexes can be employed in manufacturing an elastomeric article that incorporates or is at least partially coated with a thermochromic agent according to the present invention. Although a natural rubber latex can be or is used in the manufacture of certain elastomeric articles, the material is less favored for products (e.g., gloves) that directly contact human skin because the potential to cause allergic reactions on the part of users. Hence, synthetic latexes, such as nitrile rubber polymers, are more increasing in use. As a synthetic rubber made by the polymerization of acrylonitrile with butadiene by free-radical catalysis, nitrile rubber exhibit relatively strong tensile strength (psi) of about 1000-3000. Synthetic latexes are usually produced by emulsion polymerization using a variety of initiators, surfactants, and monomers. The latter commonly may include, for example, acrylates, styrene-butadiene (SBR), or vinyl acetate components, while more exotic formulations may include allylic compounds.

Other possible synthetic latex polymers may include, for instance, isoprene polymers, chloroprene polymers, vinyl chloride polymers, S-EB-S (styrene-ethylene-butylene-styrene) block copolymers, S-I-S (styrene-butadiene-styrene) block copolymers, S-I (styrene-butadiene) block copolymers, S-B (styrene-butadiene) block copolymers, butadiene polymers, styrene-butadiene polymers, carboxylated styrenen-butadiene polymers, arylonitrile-butadiene polymers, acrylonitrile-styrene-butadiene polymers, carboxylated acrylonitrile-styrene-butadiene polymers,derivatives thereof, and so forth. Examples of some suitable S-EB-S block copolymers are described in U.S. Pat. No. 5,112,900 to Buddenhagen et al., U.S. Pat No. 5,407,75 to Buddenhagen et al., U.S. Pat. No. 5,900,452 to Plamthottam, and U.S. Pat. No. 6,288,150 to Pattonhagen, the contents of which are incorporated herein by reference.

Typically, latexes are used in coatings (e.g., latex paint) and glues because they solidify by coalescence of the polymer particles as the water evaporates, and therefore can form films without releasing potentially toxic organic solvents in the environment. Other uses include cement additives. Latexes, either nature or synthetic, commonly are used to make stretchable films or elastomeric products (e.g., latex gloves, latex balloons). The products are typically made using a dipping process, in which a mould or former is coated in a bath of latex, lifting the former out of the latex, and allowing it to dry and curing before removing the article from the mould. Other latex processing steps, such as spray coating and halogenation treatments may also be employed.

The elastomeric article may have either a single- or multiple layers. For instance, the article may include a coating or layer that overlies at least a portion of the elastomeric material. In an embodiment, a doning layer may be applied to facilitate the insertion of an elastomeric glove over a user's hand. Some examples of suitable materials for donning layer include, but are not limited to, polybutadienes, polyurethanes, or block copolymers.

Latex has been the material of choice for examination gloves because it is tear resistant, elastic and preserves tactile sensitivity for the wearer. However, an increase in latex allergies in both patients and health care workers has led to use of non-latex examination gloves. Nitrile, or polybutydiene-acrylonitrile, examination gloves have been used as an alternate to latex examination gloves for about the last decade, and they have been shown to perform comparably with latex as effective barriers.

Nitrile gloves are made of synthetic polymer formed by combining the monomers of acrylonitrile, butadiene and carboxylic acid monomers. Each monomer contributes a unique property. For example, acrylonitrile provides penetration resistance from a number of solvents and chemicals such as hydrocarbon oils, fats and solvents. The chemical resistance and stiffness of the gloves increases as the acrylonitrile concentration increases. Natural rubber, on the other hand, is not very resistant to chemicals. Butadiene adds softness and flexibility and contributes to the elasticity of the glove. Carboxylic acid monomers contribute to the tensile strength, or tear resistance, of the glove. By changing the composition of these monomers, the characteristics of the glove can be altered.

For purpose of illustration, one can prepare a rubber glove using the present polymeric composition. In some embodiments, a former having the shape of the article, such as a hand shape for an elastomeric glove, is initially dipped into a bath containing a coagulant for an elastomeric material. The bath may also include other optional ingredients, such as a surfactant, water, and a salt that contains calcium ions (e.g. calcium nitrate and/or calcium carbonate). The salt, for instance, may break the protection system of natural rubber latex emulsions and also facilitate removal of the tacky latex from the former, thus acting as a release agent. The surfactant may provide good wetting to avoid forming a meniscus and trapping air between the form and the deposited latex, particularly in the cuff area. If desired, the former may be preheated so that that the residual heat dries off the water leaving, for example, calcium nitrate, calcium carbonate, and surfactant on the surface of the former. Other suitable coagulant solutions are also described in U.S. Pat. No. 4,310,928 to Joung, which is incorporated herein in its entirety by reference.

After being immersed in the coagulant composition, the former is withdrawn and allowed to dry. The former may then be dipped into a tank containing an elastomeric polymer bath to form the substrate body. The bath contains, for example, natural rubber latex, stabilizers, antioxidants, curing activators, organic accelerators, vulcanizers, and so forth. The former is dipped into one or more latex baths a sufficient number of times to build up the desired thickness on the former. By way of example, the substrate body may have a thickness from a bout 0.1 to about 0.3 millimeters. If a glove is being formed, a bead roll station may be utilized to impart a cuff thereto. The latex-coated former is then dipped into a leaching tank in which hot water is circulated to remove the water-soluble components, such as residual calcium nitrates and proteins contained in the natural latex. This leaching process may continue for about 12 minutes with the tank water being about 49 C. The article may be then optionally dipped into a solution to form a coating. One coated, the former is then sent to a curing station (e.g. oven) where the latex is vulcanized or cured. The elastomeric article may then applied with various other treatment composition (e.g. lubricant, halogenation, etc.), either “off-line” (i.e., after stripping) or “on-line”.

A beneficial advantage of a protective glove that is made with the present reverse thermochromic latex compositions may be a capability of the glove to provide a warning mechanism to the wearer, when the protective glove is punctured or ruptured or otherwise breached. As a specific example, a thermochromic elastic article in the form of a protective glove may be provided wherein at least one of the thermochromic colorant in the elastic polymeric composition has a transition temperature near normal human body temperature (˜36.6° C.), whereby the color changes if the temperature is either more or less than about 35-40° C. In this case, a tear or even a small puncture in the protective glove may produce a clear visual indication due to a change in color as a result of evaporative cooling of moisture from the wearer's skin. If the evaporative cooling reduces the temperature of the reverse thermochromic elastic article in the region surrounding the breach to a temperature below the transition temperature of the thermochromic pigment, the region surrounding the breach will undergo color change to signal both the fact that a breach has occurred and the specific location of the breach. Alternatively, other kinds of articles and permutations of reverse thermochromic colorants or combinations thereof with particular, predetermined transition temperatures can help a user to monitor relative body temperature to prevent either over heating or hypothermia.

The manifestation of color change is rapid and may be readily detected within a relatively short period of time. Generally, it is desired that the reverse-thermochromic colorant exhibits a visual change in color may occur within about 30 seconds or less when exposed to a heat source. In other examples, the color change is about 15 seconds or less, and in certain embodiments, about 5 seconds or less, desirably within 1 or 2 seconds. Further, the visual color change may remain observable for a sufficient length of time, such as at least about 1-3 seconds or more, in some embodiments about 5 seconds or more, and further in some embodiments, from about 10 seconds to about 1 minute. The extent of the color change, which may be determined either visually or using instrumentation (e.g., optical reader), is also generally sufficient to provide a “real-time” indication. This color change may, for example, be represented by a certain change in the absorbance reading as measured using a conventional test known as “CIELAB”, which is discussed in POCKET GUIDE TO DIGITAL PRINTING by F. Cost, Delmar Publishers, Albany, N.Y., ISBN 0-8273-7592-1 at pages 144 and 145. This method defines three variables, L*, a*, and b*, which correspond to three characteristics of a perceived color based on the opponent theory of color perception. The three variables have the following meaning:

L*=Lightness (or luminosity), ranging from 0 to 100, where 0=dark and 100=light;

a*=Red/green axis, ranging approximately from −100 to 100; positive values are reddish and negative values are greenish; and

b*=Yellow/blue axis, ranging approximately from −100 to 100; positive values are yellowish and negative values are bluish.

Because CIELAB color space is somewhat visually uniform, a single number may be calculated that represents the difference between two colors as perceived by a human. This difference is termed ΔE and calculated by taking the square root of the sum of the squares of the three differences (ΔL*, Δa*, and Δb*) between the two colors. In CIELAB color space, each ΔE unit is approximately equal to a “just noticeable” difference between two colors. CIELAB is therefore a good measure for an objective device-independent color specification system that may be used as a reference color space for the purpose of color management and expression of changes in color. Using this test, color intensities (L*, a*, and b*) may thus be measured using, for instance, a handheld spectrophotometer from Minolta Co. Ltd. of Osaka, Japan (Model # CM2600d). This instrument utilizes the D/8 geometry conforming to CIE No. 15, ISO 7724/1, ASTME1164 and JIS Z8722-1982 (diffused illumination/8-degree viewing system. The D65 light reflected by the specimen surface at an angle of 8 degrees to the normal of the surface is received by the specimen-measuring optical system. Typically, the color change that results is represented by a ΔE of about 2 or more, in some embodiments about 3 or more, and in some embodiments, from about 5 to about 50. For general applications in an article or product, a change in color of the reverse-thermochromic colorant should be observable by an unaided human eye under either natural daylight or ambient artificial (e.g., fluorescent or incandescent) normal lighting conditions; thus, desirably the reverse-thermochromic colorant can exhibit Delta E (ΔE) changes of >3.

As used herein, the phrase “normal lighting conditions” refers to the relative intensity or brightness of light as expressed in lux. To gauge an understanding of what this term means is provided by the following examples: an over cast summer day is estimated to between 30,000 lx and 40,000 lx and a mid-winter day 10,000 lx. BS 8206 Part 1 deals in general terms with the code of practice for artificial light. The following gives some general guidance for the light requirements for a work place:
General office, laboratories, kitchen—500 lx
Drawing offices—750 lx
Tool rooms and paintwork—1000 lx
Inspection of graphic reproduction—1500 lx.
   In a surgical theater the light requirement would be similar to that of the graphic reproduction inspection, so typically greater or equal to about 1500 lx. The Commission Internationale de l'Eclairage (CIE), which has established standards for illumination, has set the ideal standard light for use in color matching. The illumination of color temperature of 6500K, with UV content near north daylight is known as D65.

The reverse thermochromic colorant, such as Reichardt's dye, is de-colorized when in an acidic microenvironment. When present in the polymer solution, the dye is de-colorized; thus, addition of a strong base during the solution phase can help bring back some of the color. When the colorant is incorporated into the solidified polymer matrix and its temperature is cool, the dye is encased in this relatively acidic microenvironment, leading to a de-colorized state. Not to be bound by theory, we believe that the color change may result from a conformation change of the polymeric matrix when exposed to heat. Application of heat to the polymer matrix allows for movement of the polymer chains and likely exposure of the dye molecule to different regions or substituents of the polymer chains or additives that may be more alkaline or basic in nature, causing a color change. This color intensifies as the heat intensifies, potentially because the polymer chains move more with heat and the dye becomes freer to interact with the other more basic parts of the matrix. The fact that color changes, for instance, from whitish clear to pink/magenta and not to blue/purple may signify that the polymer matrix more closely resembles a glycerol/glycol or acetone-like solvent state.

### SECTION III.—EXAMPLES

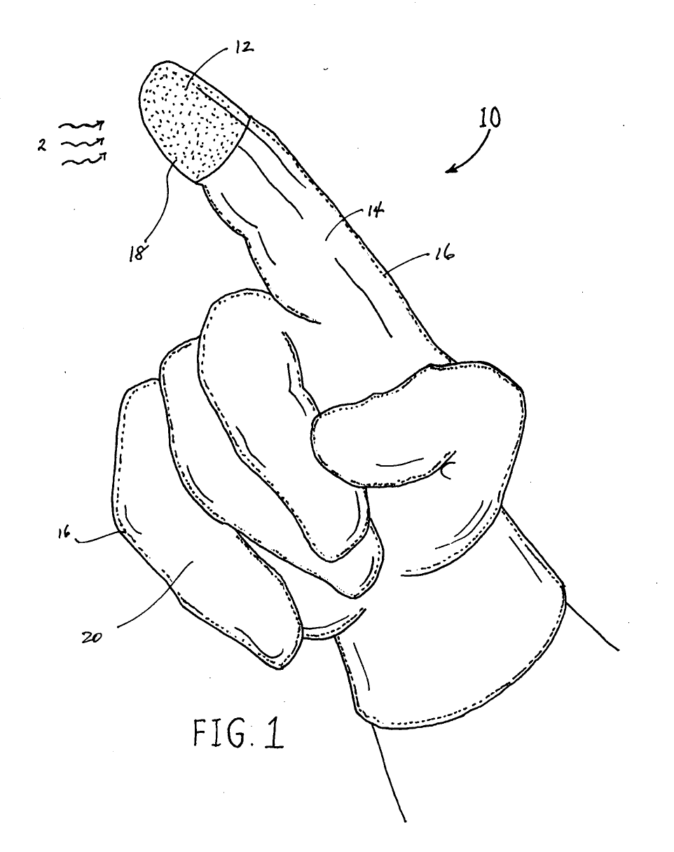

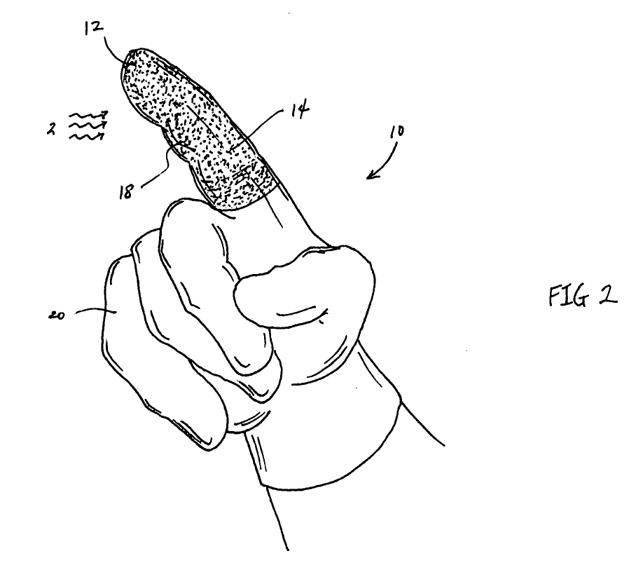

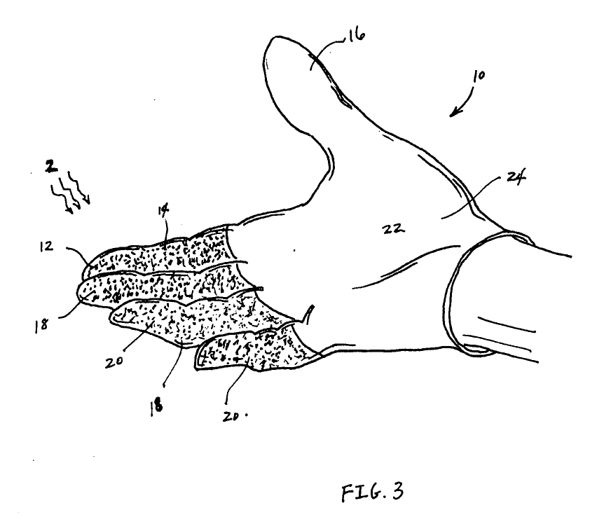

The following examples illustrate simple, vivid visual color changes, according to the present invention, to indicate time duration and a time to change message can be delivered. FIGS. 1-3, are schematic illustrations of a glove with color-changing characteristics of an elastic membrane according to the present invention.

### Example 1

As a specific example of an embodiment of the foregoing, a temperature responsive elastic color changing article was produced as follows. First, a base latex compounding emulsion was produced using Synthomer in deionized water. Synthomer is a nitrile rubber latex, specifically a carboxylated butadiene-acrylonitrile rubber latex, available from Synthomer Ltd. of Harlow, Great Britain. The base latex compounding emulsion additionally included about 1 weight percent ammonia, about 2 weight percent curing/crosslinking agent, and about 1 weight percent kaolin clay as a filler and opacifier.

For instance, 3 grams of Reichardt's dye powder, available from Aldrich Chemical Co. Milwaukee Wis., was added to about 250 milliliters of the latex compounding emulsion and mixed together by stirring to form a latex compounding emulsion having about 1 weight percent of the reverse-thermochromic pigment ingredient.

Next, a cylindrical-shaped former was heated to about 90° C. and dipped into the pigment-containing latex compounding emulsion to coat the former. The former was placed into an oven heated at 90° C. to cure for about 10 minutes. When removed from the oven, the reverse-thermochromic elastic article coated onto the former was essentially colorless, but upon cooling below the transition temperature (˜31° C.) reverted to the purple color. When the reverse-thermochromic elastic article was removed from the former, it was capable of repeatedly changing color from cream to bright pink and back as it was warmed from ambient temperature (approximately 20° C.), to a temperature above 31° C., and then allowed to cool again to ambient temperature.

To verify elasticity of the Example material, a sample of the elastic film material thus made was stretched and released by hand to ensure the material was capable of elastic stretch and recovery. A strip of the elastic film material measuring 11 centimeters long and I centimeter wide, and having a thickness of about 0.5 millimeter, was held at each end by thumb and forefinger, leaving 9 centimeters of the film material exposed between the gripped ends as measured on a ruler. The film was then stretched by hand to 18 centimeters (i.e., extended to 200 percent of its original length), and then the stretching force was removed and the film allowed to relax. The film initially relaxed or recovered to a length of 9.5 centimeters (i.e., demonstrating an immediate recovery of about 94 percent), and after 1 minute, the film material had returned to its original length of 9 centimeters (100 percent recovery).

### Example 2

In making the gloves, we used a standard glove porcelain former that was dipped into a standard CaNO₃ coagulant and then dipped into a nitrile solution containing Reichardt's dye. The dye was added to the solution at a concentration of approximately 0.2%. The pH of the dye solution was adjusted using KOH to a final pH of approximately 10.0, and a small amount (approximately 5 mL) of surfanol was added to the solution to enhance solubility of the Reichardt's Dye. Addition of the KOH caused a color change from white to pink. Presence of a base can modulate or alter the color changes of the polymeric substrate material before the thermochromic shift. After dipping the former into this mixture, standard nitrile glove making procedure was followed. It was noticed that drying in the oven at about 70° C. induced a color change to a very dark pink, but that the light color was restored upon cooling to room temperature. An additional glove sample was made by adding 0.2% Reichardt's dye directly to the coagulant solution. The former was dipped in the coagulant, and then dipped into the nitrile/Reichardt's dye/KOH/surfanol mixture, followed by standard glove making practice. It was again noticed that drying in the oven resulted in a color change to a deep magenta, but that the original crème color was restored when cooled to room temperature. The deep color could also be generated by gently applying heat from a heat gun to the nitrile for less than a minute.

### Example 3

It is worth noting that previous attempts to incorporate Reichardt's dye into polymer melts (using an extruder for instance) or onto other substrates or polymers have not resulted in observation of a reversible thermochromic shift. For example, Reichardt's dye (1%) was added to polyethylene resin and extruded to make a film that was blue in color. This film does not undergo a color change when exposed to heat. Similarly, previous studies which coated Reichardt's dye onto various substrates such as nonwoven spunbond-meltblown-spunbond (SMS) materials, fibrous sheets, paper, or woven cloth did not result in any observable thermochromism.

The solvatochromic nature of Reichardt's dye leads to different colors depending on the solvent environment. Dissolution of Reichardt's dye into certain solvents (such as glycerol, methanol, etc) results in a red color, while dissolution into other solvents (such as acetonitrile, isopropanol, etc) result in a bluish/purplish color. When solutions of Reichardt's dye in methanol and in glycerol were heated using a heat gun, the solutions underwent a shift from pink to deep red/violet. Application of heat to a purple solution of Reichardt's dye in acetonitrile did not cause any observable color change. Literature reports, however, suggest that thermochromism should be possible in this solvent. The shift may be too small, however, to be immediately visible to the naked eye. It appears that the best conditions for usage of Reichardt's dye as a thermochromic visual indicator would be to leverage solvents and polarity environments that favor the shift of deep magenta. Nitrile (or additives in the glove solution) appears to create this environment.

It is envisioned that the reverse-thermochromic colorant technology of the present invention may be adapted for a variety of different uses. For instance, the colorant composition can be used in garments or protective articles used in health care environs, diapers, product shelf-life indicators, stand alone timers for children. In addition, color-active designs, symbols, or prints could be part of outdoor garments or swimming suits and other beach wear to indicate to a wear or caregiver when to apply more sun-screen.

In other embodiments, the reverse thermochromic polymeric matrix material can be applied to a timer or time indictor device. In certain health or hygiene related products or systems, manufacturers have expressed an interests for a simple indicator to inform the user when to change or replace the product article. Examples of the articles may include disposable gloves, gowns, drapes and covers which have to be replaced or changed in order to reduce infectious bacterial or other contamination or cross contamination. Many products, for example, personal care products, such as absorbent pads or other articles are intended to be used for a limited period of time. In some circumstances it would be advantageous for the product to visually convey a message to the individual using the product at the recommended time to change time. For example, many disposable products such as gloves or gowns should be replaced after a defined period of time. After the designated time, the products may have lost some efficacy or most likely be contaminated, thus making it advantageous for the wearer of the product to replace the old product with a new product. A graphic or message appearing on the product at the designated time would alert the wearer and those in the immediate surroundings that it is time to change the product. In another example, a small child using a training pant could be positively reinforced after wearing the training pant for some extended period of time.

The thermochromic elastic articles described herein are highly suited for use in medical care products, protective wear garments, and the like. Many other uses are possible. For example, the thermochromic elastic articles may be incorporated into or used in other medical devices or products such as circulation monitors and post-surgical coverings for extremities, and compressive elastic wraps such as medical wraps capable of indicating heating or cooling states. As an example, an elastic bandage made from or including a thermochromic elastic article of the invention may be used alone as a compressive wrap capable of producing visual signal of possible presence of wound infection if the thermochromic elastic article is configured to undergo color change at temperatures somewhat above normal human skin temperature, and/or may be capable of visual indicating a state of reduced circulation in an extremity if the thermochromic elastic article is additionally or alternatively configured to undergo color change at temperatures somewhat below normal human skin temperature.

As still another example, the thermochromic elastic article may be provided as an elastic compressive wrap material used to maintain proper positioning of heating or cooling therapy packs, and be capable of providing at-a-glance feedback to a medical professional or other caregiver as to the status or current performance of the heating or cooling pack. For example, a thermochromic compressive wrap configured to undergo color change at a temperature moderately above (and/or below) normal human skin temperature can provide visual indication when the heating or cooling functionality of the therapy pack has been exhausted.

The thermochromic elastic articles may also be beneficially incorporated into garments, for example into children's toilet training pants, disposable swimwear, or other pant-type or diaper-like products where it is desirable to have an elastic member capable of indicating temperature change. Incorporation into other types of garments where stretchable color-changing properties are desired is also of course possible. As a specific example, such pant-type products often include elastic side panel materials to ensure a secure and comfortable fit. The thermochromic elastic articles may be provided as or incorporated into the elastic side panel materials, or in other portions of such garments, to provide temperature indicating properties along with elastic properties.

Such an elastic panel may include the thermochromic elastic article as a layer in a multi-layered laminate material, and/or include the thermochromic elastic article as an elastic portion of the material in an adjacent relationship with one or more other elastic or non-elastic materials. By way of example, it may be desirable to have the thermochromic elastic article provided with more cloth-like aesthetic properties on a user-facing or skin-facing side by layering or laminating the elastic article with a cloth-like facing. Exemplary cloth-like facings include fabrics such as woven, knitted and nonwoven fabrics. Desirably, such a cloth-like facing may be extensible so as not to impede the extensibility of the thermochromic elastic article.

As still another example, the thermochromic elastic articles of the invention may be provided in the form of an article capable of indicating input of mechanical work energy by undergoing a color change transition as the article becomes warmed due to repetitive stress (i.e., by repetitive flexing or stretching of the article). Such a stress indicating article can serve to signal impending failure of the article, or may instead serve as a semi-quantitative measure of the amount of work performed. As one example, elastic bands are often used for exercise programs, both for general fitness and for purposes of medical rehabilitation necessitated by injury or disease. Such elastic bands are commonly provided in the form of flat film sheets or flat film ribbons, and are also commonly provided in the form of tubes, such as generally cylindrical tubes, for example. Elastic bands may also be provided in the form of shaped solid bands, such as for example in the form of solid cylindrical bands or solid bands having a generally oval or square cross section, and the like.

The thermochromic elastic articles may be provided in the form of stress indicating articles such as exercise bands that are capable of indicating whether a “light”, “moderate” or “strenuous” level of exercise has been achieved by the user, depending on the transition temperature of the thermochromic pigment(s) incorporated into such an exercise band. For example, a lower transition temperature thermochromic pigment(s) may be selected for use in a thermochromic elastic article for lighter intended workouts, and a higher transition temperature thermochromic pigment(s) may be selected for use in a thermochromic elastic article for more strenuous intended workouts.

In addition, a single thermochromic elastic article may be capable of indicating any or all of the above. For example, a thermochromic elastic article provided as a stress indicating exercise band may be provided having multiple thermochromic pigments P1 (blue), P2 (yellow) and P3 (red) all in the colored state at an intended ambient temperature, and having distinct transition temperatures respectively T1, T2 and T3, and where T1<T2<T3. Prior to beginning exercise, the thermochromic elastic exercise band may have a generally brownish appearance resulting from the mixture of the three primary colored pigments. After a light amount of exercise, as the band warms, the blue pigment decolorizes and the exercise band becomes generally orange in appearance. After a moderate amount of exercise, as the band warms further, the yellow pigment decolorizes and the exercise band becomes generally reddish in appearance. Finally, upon further exercise, as the band warms still further, the red pigment decolorizes and the exercise band becomes generally colorless or whitish in appearance.

While the thermochromic elastic articles disclosed and described herein have been described primarily with respect to a number of exemplary embodiments, it is envisioned that many other embodiments of the thermochromic elastic articles may be suitably and desirably constructed. For example, thermochromic elastic articles may desirably be provided in the form of elastic novelty items. As just one specific example, the thermochromic elastic article may be provided in the form of user-inflated elastic balloons. Such thermochromic elastic balloons can provide enjoyment and amusement by changing color when held in (and warmed by) the hands.

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

Although the present invention has been described generally and in detail by way of examples and the accompanying figures, persons of skill in the art will understand that the invention is not necessarily limited to the particular embodiments, but that modifications and variations may be made without departing from the spirit and scope of the invention defined by the following claims.

We Claim:

1. An elastomeric composition comprising a flexible, polymeric matrix and a reverse-thermochromic colorant including a solvatochromic dye.

2. The elastomeric composition according to claim 1, wherein said solvatochromic dye has a phenolate betaine structure.

3. The elastomeric composition according to claim 1, wherein said reverse-thermochromic colorant exhibits a change in color wavelength of at least about 10 nm over the human visible spectrum, of about 400 nm to about 700 nm.

4. The elastomeric composition according to claim 3, wherein said reverse-thermochromic colorant expresses a change in a color wavelength of about 20-30 nm up to about 40-130 nm.

5. The elastomeric composition according to claim 1, wherein said reverse-thermochromic colorant exhibits a Delta E (ΔE) change of >3.

6. The elastomeric composition according to claim 5, wherein said reverse-thermochromic colorant is observable by an unaided human eye under normal lighting conditions.

7. The elastomeric composition according to claim 1, wherein said reverse-thermochromic colorant exhibits a color change when exposed to a heat source within a period of about 30 seconds.

8. The elastomeric composition according to claim 1, wherein said polymeric matrix includes a dipole orientating agent that induces said solvatochromic dye to express locally when subjected to a temperature change.

9. The elastomeric composition according to claim 3, wherein said dipole-inducing agent is a one of the following: glycerin, tetrahydrofuran, pyridine, dimethylformamide, isopropanol, or acetonitrile.

10. The elastomeric composition according to claim 3, wherein said dipole-inducing agent is an acid group.

11. The elastomeric composition according to claim 3, wherein said acid group is methacrylic acid.

12. The elastomeric composition according to claim 1, wherein said phenolate betaine dye is Reichardt's dye.

13. The elastomeric composition according to claim 1, wherein the flexible matrix is made of a latex resin.

14. The elastomeric composition according to claim 8, wherein the latex resin is an acrylo-nitrile butadiene resin.

15. The elastomeric composition according to claim 1, wherein said colorant changes color at temperatures over a range from about 5° C. to about 85° C.

16. The elastomeric composition according to claim 10, wherein said colorant undergoes a change in color from an uncolored state to a colored state over a temperature difference of at least 2° C.

17. The elastomeric composition according to claim 1, wherein said colorant exhibits a perceivable color change in wavelength of at least about 10 nm over human visible spectrum.

18. The elastomeric composition according to claim 1, wherein a base is present to modulate a starting color of said polymeric matrix material before a thermochromic shift.

19. A method for indicating a change in temperature or environmental condition, the method comprises: providing an article having an elastic or flexible polymeric matrix material, with a dipole-inducing agent and a solvatochromic dye with a phenolate betaine structure admixed in said polymeric matrix; exposing said article to a temperature change to manifest a color change from a translucent or uncolored state to an opaque or colored state.

20. The method according to claim 19, wherein said reverse-thermochromic colorant exhibits a change in color wavelength of at least about 10 nm over the human visible spectrum, of about 400 nm to about 700 nm.

21. The method according to claim 19, wherein said reverse-thermochromic colorant exhibits a Delta E (ΔE) change of >3.

22. The method according to claim 19, wherein said reverse-thermochromic colorant is observable by an unaided human eye under either natural daylight or ambient artificial normal lighting conditions.

23. The method according to claim 19, wherein said reverse-thermochromic colorant exhibits a color change when exposed to a heat source within a period of about 30 seconds.

24. A protective or indicator article comprising a flexible polymeric membrane having either a natural or synthetic latex matrix, a dipole-inducing agent, and a solvatochromic dye with a phenolate betaine structure admixed in said rubber matrix.

25. The article according to claim 24, wherein said dipole-inducing agent is an acid group.

26. The article according to claim 24, wherein said acid group is a methacrylic acid.

27. The article according to claim 24, wherein said phenolate betaine dye is Reichardt's dye.

28. The article according to claim 24, wherein said latex matrix is an acrylo-nitrile butadiene rubber.

29. An article of manufacture comprising a flexible polymeric matrix and a reverse-thermochromic colorant including a solvatochromic dye with a phenolate betaine structure.

30. The article of manufacture according to claim 29, wherein said polymer matrix is a nitrile butadiene rubber.

31. The article of manufacture according to claim 29, wherein said reverse-thermochromic colorant exhibits a Delta E (ΔE) change of >3.

32. The article of manufacture according to claim 31, wherein said reverse-thermochromic colorant is observable by an unaided human eye under natural lighting conditions.

33. The article of manufacture according to claim 29, wherein said reverse-thermochromic colorant exhibits a color change when exposed to a heat source within a period of about 30 seconds.

34. The article of manufacture according to claim 29, wherein the article is one of the following: a glove, a face mask, a protective garment, a condom, an inflatable cuff, an external catheter, a catheter balloon, a dilation balloon, an instrument cover, a medical wrap, or a stress indicating article.

35. The article of manufacture according to claim 29, wherein the article is flexible container.

36. The article of manufacture according to claim 35, wherein said container is a pouch or bag.

37. The article of manufacture according to claim 29, wherein the article is a sticker or temporary tattoo.

38. A thermochromic elastic article comprising: a first elastic polymeric composition having elastomeric polymer selected from the group consisting of elastomeric emulsion polymers and elastomeric solution polymers, the first elastic polymeric composition further comprising a first reverse-thermochromic colorant including a solvatochromic dye with a phenolate betaine structure that is substantially uniformly dispersed in the elastic polymeric composition, wherein said reverse-thermochromic colorant exhibits a change in color wavelength of at least about 10 nm over the human visible spectrum, of about 400 nm to about 700 nm, and exhibits a Delta E (ΔE) change of >3.

39. The thermochromic elastic article according to claim 38, wherein said reverse-thermochromic colorant exhibits a color change within a period of about 30 seconds, when exposed to a heat source.

40. The thermochromic elastic article according to claim 38, wherein said reverse-thermochromic colorant is observable by an unaided human eye under either natural daylight or ambient artificial normal lighting conditions.

41. The thermochromic elastic article of claim 38, wherein the first elastic polymeric composition comprises at least one elastomeric polymer selected from the group consisting of natural latex polymers and synthetic latex polymers.

42. The thermochromic elastic article of claim 38, wherein said elastic polymeric composition comprises between about 0.1 weight percent and about 10 weight percent of reverse thermochromic colorant.

43. The thermochromic elastic article of claim 38, wherein the first elastic polymeric composition comprises between about 0.5 weight percent and about 7 weight percent of reverse thermochromic colorant.

44. The thermochromic elastic article of claim 38, wherein the first elastic polymeric composition comprises a second reverse thermochromic colorant.

45. The thermochromic elastic article of claim 44, the reverse thermochromic colorant having a first transition temperature and the second reverse thermochromic colorant having a second transition temperature, and wherein the difference between the first transition temperature and the second transition temperature is not more than about 1° C.

46. The thermochromic elastic article of claim 38, the first reverse thermochromic colorant having a first transition temperature and the second reverse thermochromic colorant having a second transition temperature, and wherein the difference between the first transition temperature and the second transition temperature is at least about 2° C.

47. The thermochromic elastic article of claim 44, the first reverse thermochromic colorant having a first transition temperature and the second reverse thermochromic colorant having a second transition temperature, and wherein the difference between the first transition temperature and the second transition temperature is at least about 4° C.

48. The thermochromic elastic article of claim 38, wherein the thermochromic elastic article further includes at least one non-thermochromic pigment.

49. The thermochromic elastic article of claim 38, wherein said article has a multilayer construction, such that the second elastic polymeric composition is substantially the same as the first elastic polymeric composition.

50. The thermochromic elastic article of claim 38, where said article has a multilayer construction, such that the reverse thermochromic colorant in the second elastic polymeric composition differs from the reverse thermochromic colorant in the first elastic polymeric composition.

51. The thermochromic elastic article of claim 50, the reverse thermochromic colorant in the first elastic polymeric composition having a first transition temperature and the reverse thermochromic colorant in the second elastic polymeric composition having a second transition temperature, wherein the difference between the first transition temperature and the second transition temperature is at least about 2° C.

52. The thermochromic elastic article of claim 38, wherein said first elastic polymeric composition includes a base to alter a starting color of said elastomeric polymer before a thermochromic shift.

53. An article of manufacture comprising the thermochromic elastic article of claim 38, wherein said article of manufacture selected from the group consisting of a glove, a medical wrap, a garment and a stress indicating article.
